(19) United States
(12) Patent Application Publication
(10) Pub. No.: US 2012/0108290 A1
(43) Pub. Date: May 3, 2012

(54) MOBILE ELECTRONIC APPARATUS, METHOD FOR IMAGE MANAGEMENT AND RECORDING MEDIUM

(75) Inventors: Akira SHINOZAWA, Kawasaki (JP); Katsuaki AKAMA, Kawasaki (JP)

(73) Assignee: FUJITSU LIMITED, Kawasaki-shi (JP)

(21) Appl. No.: 13/253,558

(22) Filed: Oct. 5, 2011

(30) Foreign Application Priority Data
Oct. 29, 2010 (JP) 2010-244260

(51) Int. Cl. H04W 88/02

(52) U.S. Cl. 455/556.1

(57) ABSTRACT

A mobile electronic apparatus includes a storage unit which stores an image shot by an image shooting unit, a region information obtaining unit which obtains region information indicating in which one of a plurality of regions the mobile electronic apparatus is located, a move identifying unit which identifies whether the mobile electronic apparatus moved from a first region to a second region on the basis of the region information obtained by the region information obtaining unit and a connection unit which connects, upon the move identifying unit identifying that the mobile electronic apparatus moved from the first region to the second region, an image stored in the storage unit after the mobile electronic apparatus moved from another region to the first region with a region identifier of the first region.

### CROSS-REFERENCE TO RELATED APPLICATIONS

This application is based upon and claims the benefit of priority of the prior Japanese Patent Application No. 2010-244260, filed on Oct. 29, 2010, the entire contents of which are incorporated herein by reference.

### FIELD

The embodiment discussed herein is related to a mobile electronic apparatus, a method for image management and a recording medium.

### BACKGROUND

An ordinary mobile electronic apparatus such as a mobile phone transmits and receives radio waves to and from wireless base stations located here and there, and can identify where the apparatus is located by observing which wireless base station is covering the apparatus in its service coverage. A technology is disclosed in Japanese Laid-open Patent Publication No. 10-155046 such that a shot image and a piece of region information regarding where the image was shot are connected with each other and stored by the use of a technology for identifying where an electronic apparatus is located.

In particular, Japanese Laid-open Patent Publication No. 10-155046 discloses obtaining a piece of region information indicating where an electronic apparatus is located by transmitting and receiving radio waves to and from wireless base stations, and connecting the region information with a shot image, so that a folder can be made for each of regions where images are shot. As a result, the images can be simply managed.

Incidentally, according to the technology disclosed in Japanese Laid-open Patent Publication No. 10-155046, every time an image is shot, the shot image and a piece of region information regarding where the image was shot are connected with each other and stored in a storage unit. However, how to deal with a shot image in a case where the electronic apparatus is located out of service coverage and, therefore, cannot transmit and receive radio waves to and from wireless base stations is not explained.

### SUMMARY

According to an aspect of an embodiment, a mobile electronic apparatus includes a storage unit which stores an image shot by an image shooting unit, a region information obtaining unit which obtains region information indicating in which one of a plurality of regions the mobile electronic apparatus is located, a move identifying unit which identifies whether the mobile electronic apparatus moved from a first region to a second region on the basis of the region information obtained by the region information obtaining unit, and a connection unit which connects, upon the move identifying unit identifying that the mobile electronic apparatus moved from the first region to the second region, an image stored in the storage unit after the mobile electronic apparatus moved from another region to the first region with a region identifier of the first region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware constitution of a mobile phone of the embodiment;

FIG. 2 is a block diagram for illustrating functions of the mobile phone of the embodiment;

FIG. 3 illustrates an exemplary region-base station conversion table;

FIG. 4 illustrates an exemplary new shot table and an exemplary image search table; and

FIG. 5 illustrates an exemplary operation of the mobile phone of the embodiment.

### DESCRIPTION OF EMBODIMENTS

An embodiment of a mobile electronic apparatus, a method for image management and a recording medium disclosed in the application will be explained in detail on the basis of the drawings. Incidentally, the disclosed art is not limited to the embodiment. According to the following embodiment, for example, a mobile phone will be explained as an example of the mobile electronic apparatus. The mobile electronic apparatus is not limited to a mobile phone, though, and may be any type of electronic apparatus having an image shooting function.

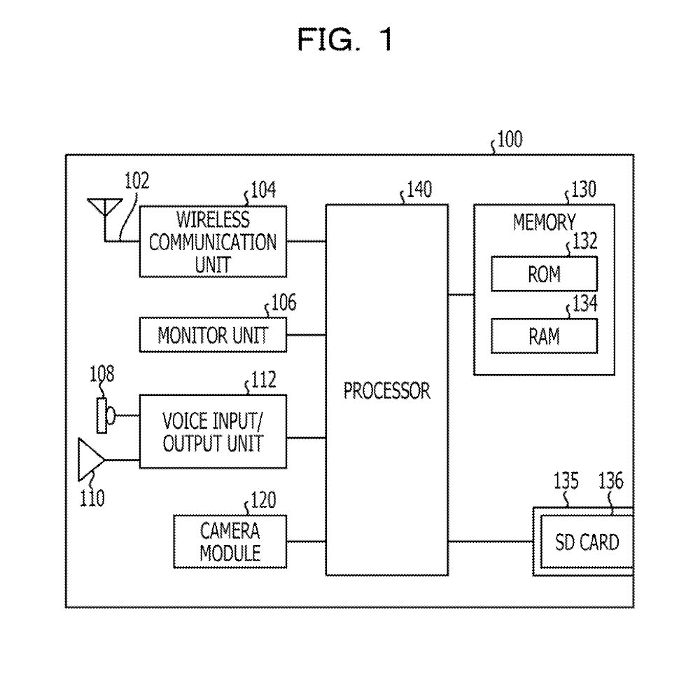

FIG. 1 illustrates a hardware constitution of the mobile phone of the embodiment. As illustrated in FIG. 1, the mobile phone 100 of the embodiment has an antenna 102, a wireless communication unit 104, a monitor unit 106, a microphone 108, a speaker 110, a voice input/output unit 112 and a camera module 120. The mobile phone 100 has a memory 130, an SD (Secure Digital) card loading slot 135 and a processor 140, as well. The mobile phone 100 can be loaded with an SD card 136 in the SD card loading slot 135.

The wireless communication unit 104 transmits and receives voice and various data including characters wirelessly via the antenna 102. The monitor unit 106 is an output interface such as a liquid crystal panel on which various data including characters and images are displayed. Further, the voice input/output unit 112 is an input/output interface that voice is inputted to via the microphone 108 and that voice is outputted from via the speaker 110.

The camera module 120 has parts including a lens, an image sensor, a signal processing device, etc. and obtains image data by means of an image shooting function. The memory 130 has a ROM (Read Only Memory) 132 in which data that the mobile phone 100 needs for running its various functions is stored, and a RAM (Random Access Memory) 134 in which various programs for running various functions are stored.

The processor 140 is a CPU (Central Processing Unit) which runs the various programs stored in the RAM 134. The processor 140 controls the wireless communication unit 104, the monitor unit 106, the voice input/output unit 112 and the camera module 120 described above by running the various programs stored in the RAM 134. Incidentally, the programs to be run by the processor 140 can be stored not only in the RAM 134 but in a recoding medium which can be distributed such as a CD (Compact Disc)-ROM or a memory medium. The processor 140 can read the programs from the recoding medium so as to run the programs. Further, the programs can be stored in a server connected via a network so that the programs can be run on the server. The server can provide the mobile phone 100 being connected to the server via the network with a service as requested by the service requestor, i.e., the mobile phone 100.

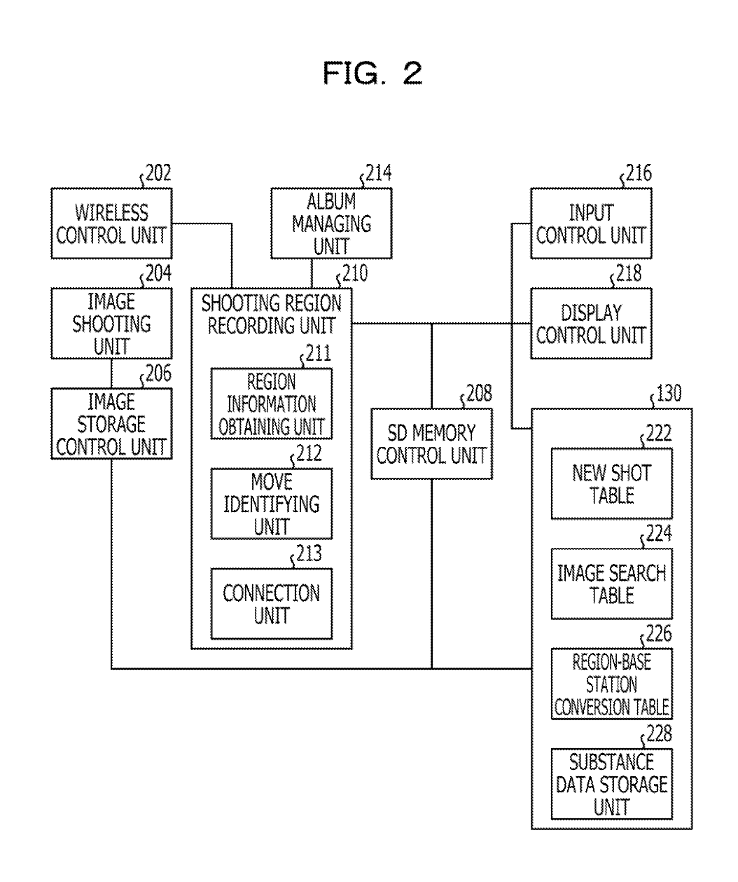

FIG. 2 illustrates functional blocks of the mobile phone of the embodiment. As illustrated in FIG. 2, the mobile phone 100 has a wireless control unit 202, an image shooting unit 204, an image storage control unit 206 and an SD memory control unit 208, which are functional blocks to be implemented by means of the processor 140 running the various programs read from the RAM 134. The mobile phone 100 has a shooting region recording unit 210, an album managing unit 214, an input control unit 216 and a display control unit 218, which are functional blocks to be implemented by means of the processor 140 running the various programs read from the RAM 134, as well. Further, the shooting region recording unit 210 has a region information obtaining unit 211, a move identifying unit 212 and a connection unit 213. Further, the mobile phone 100 has a new shot table 222, an image search table 224, a region-base station conversion table 226 and a substance data storage unit 228 in the memory 130. The new shot table 222, the image search table 224, the region-base station conversion table 226 and the substance data storage unit 228 can be installed, for example, in the RAM 134, or in the ROM 132.

The wireless control unit 202 controls the wireless communication unit 104 so as to control wireless communication of voice and various data including characters. The wireless control unit 202 transmits and receives radio waves to and from one or a plurality of wireless base stations located here and there, so as to detect an identifier of one of the plural wireless base stations covering the mobile phone 100 in its service coverage, as well.

The image shooting unit 204 controls the camera module 120, so as to control the camera module 120 shooting a still or moving image. The image storage control unit 206 stores a shot image in the memory 130 if a user specifies that a shot image is stored in the memory 130 which is an internal memory. To put it more specifically, if an image is shot by means of the image shooting unit 204, the image storage control unit 206 stores substance data and an identifier of the shot image in the substance data storage unit 228 and in the new shot table 222, respectively.

The embodiment will be explained in an exemplary case where a shot image is supposed to be stored in the memory 130. Where to store a shot image is not limited to the above, and the image can be stored in the SD card 136 which is an external memory. That is, if a user specifies that a shot image is stored in the SD card 136 which is an external memory, the image storage control unit 206 stores the shot image in the SD card 136 through the SD memory control unit 208. The image storage control unit 206 stores substance data and an identifier of the shot image in the substance data storage unit 228 in the SD card 136 and in the new shot table in the SD card 136, respectively, similarly as in the case where the shot image is stored in the memory 130.

The region information obtaining unit 211 obtains region information indicating in which one of a plurality of regions the mobile phone 100 is located. To put it more specifically, the region information obtaining unit 211 obtains region information of the mobile phone 100 on the basis of an identifier of a wireless base station detected by the wireless control unit 202 and the region-base station conversion table 226.

The move identifying unit 212 identifies whether the mobile phone 100 moved from a first region to a second region on the basis of the region information of the mobile phone 100 obtained by the region information obtaining unit 211. That is, the move identifying unit 212 identifies whether the mobile phone 100 moved from one region to another region while observing the region information of the mobile phone 100 obtained by the region information obtaining unit 211.

If the move identifying unit 212 identifies that the mobile phone 100 moved from the first region to the second region, the connection unit 213 connects an image shot in the first region and stored in the memory 130 with a region identifier of the first region. In other words, if the move identifying unit 212 identifies that the mobile phone 100 moved from the first region to the second region, the connection unit 213 connects an image stored in the memory 130 after the mobile phone 100 had moved from another region to the first region with a region identifier of the first region. To put it more specifically, upon identifying that the mobile phone 100 moved from the first region to the second region, the move identifying unit 212 connects an identifier of an image stored in the new shot table 222 with a region identifier of the first region and stores the connected identifier and region identifier in the image search table 224. Then, the connection unit 213 removes the identifier of the image in the new shot table 222.

The album managing unit 214 connects a shot image with region information regarding where the image was shot, and displays the connected shot image and the region information on the monitor unit 106. The album managing unit 214 specifically obtains a connection between the shot image and the region information regarding where the image was shot by referring to the image search table 224. Then, the album managing unit 214 displays a folder of every region where an image was shot on the monitor unit 106. If a user specifies one of the folders, the album managing unit 214 displays thumbnails of images in the specified folder on the monitor unit 106. Further, the album managing unit 214 can display not only a folder of every region where an image was shot but a map on the monitor unit 106. If a user specifies a region on the map, the album managing unit 214 can display thumbnails of images shot in the specified region.

The input control unit 216 accepts input instructions entered through keys of the mobile phone 100 and input instructions entered on a screen of the monitor unit 106. The input control unit 216 accepts, for example, input instructions to shoot an image by the use of the camera module 120 or instructions to remove a shot image. The display control unit 218 carries out a control operation regarding an image to be displayed on the monitor unit 106. The display control unit 218 displays a folder of every region where an image was shot on the monitor unit 106, for example, as instructed by the album managing unit 214. Further, if one of the folders of the respective regions displayed on the monitor unit 106 is specified, the display control unit 218 displays thumbnails in the specified folder on the monitor unit 106, for example, as instructed by the album managing unit 214.

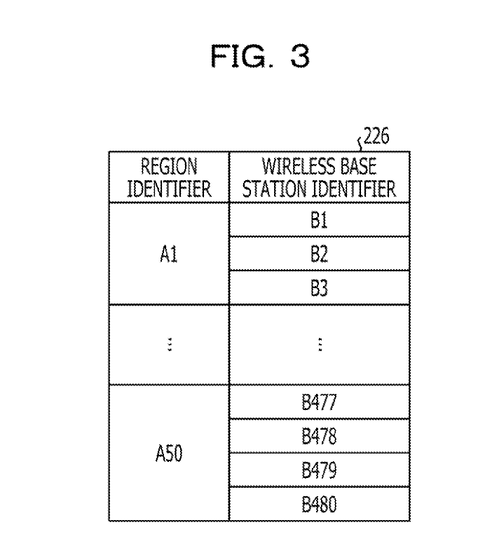

FIG. 3 illustrates an example of the region-base station conversion table 226. As illustrated in FIG. 3, the region-base station conversion table 226 is formed by a plurality of region identifiers each connected with a plurality of wireless base station identifiers. The region identifiers are formed, for example, by 50 identifiers A1-A50. Using the example of 50 identifiers for illustrative purposes, in Japan for example, prefectures may be individually allotted to A1-A50 in order, such as Hokkai-do: Dohoku, Doo, Doto, Donan, Tohoku: Aomori, Iwate, Miyagi, Akita, Yamagata, Fukushima, Kanto: Tochigi, Gunma, Ibaragi, Chiba, Saitama, Tokyo, Kanagawa, Chubu: Nagano, Yamanashi, Shizuoka, Gifu, Aichi, Mie, Hokuriku: Niigata, Toyama, Ishikawa, Fukui, Kansai: Shiga, Kyoto, Nara, Hyogo, Osaka, Wakayama, Chugoku: Tottori, Shimane, Okayama, Hiroshima, Yamaguchi, Shikoku: Kagawa, Tokushima, Ehime, Kochi, Kyushu: Fukuoka, Oita, Miyazaki, Saga, Nagasaki, Kumamoto, Kagoshima and Okinawa. In this allotment, Hokkai-do is divided into four regions which are Dohoku, Doo, Doto and Donan.

As illustrated in FIG. 3, each region identifier may correspond with multiple base station identifiers. For example, the region identifier “A1” is connected with wireless base station identifiers “B1-B3”. The region identifier “A50” is connected with wireless base station identifiers “B477-B480”. Similarly, the region identifiers except for “A1, A50” are each connected with a plurality of wireless base station identifiers. That is, if the number of wireless base stations located here and there is 480, group a plurality of adjacent wireless base stations so as to make 50 groups and allot a region identifier to each of the groups, rather than allotting 480 regions individually to the wireless base stations. Incidentally, the embodiment is explained by the use of an exemplary allotment of domestic regions, and regions can be similarly allotted in a foreign country.

If a wireless base station identifier detected by the wireless control unit 202 is “B2”, for example, the region information obtaining unit 211 extracts the region identifier “A1” corresponding to “B2”, and obtains region information saying that the mobile phone 100 is located in Dohoku region which corresponds to the region identifier “A1”. Incidentally, the embodiment indicates, for example, that the region information of the mobile phone 100 is obtained on the basis of a wireless base station identifier detected by the wireless control unit 202. How to obtain the region information is not limited to the above. If being equipped with a GPS (Global Positioning System) function, for example, the mobile phone 100 can obtain location information of the mobile phone 100 on the basis of GPS waves received from the GPS satellites, and can obtain region information on the basis of the obtained location information.

If the wireless base station identifier detected by the wireless control unit 202 changes from “B2” to “B3”, for example, the move identifying unit 212 identifies the mobile phone 100 as remaining in the same region, as the region identifiers corresponding to “B2” and “B3” are both “A1”. Meanwhile, assume that a user of the mobile phone 100 moves from the Doo region to the Tokyo region by plane while the mobile phone 100 is kept powered off, and then powers on the mobile phone 100 in the Tokyo region. In this case, as region information obtained immediately before the mobile phone 100 is powered off indicates the Doo region and region information obtained first after the mobile phone 100 is powered on indicates the Tokyo region, the move identifying unit 212 identifies the mobile phone 100 as having moved over different regions.

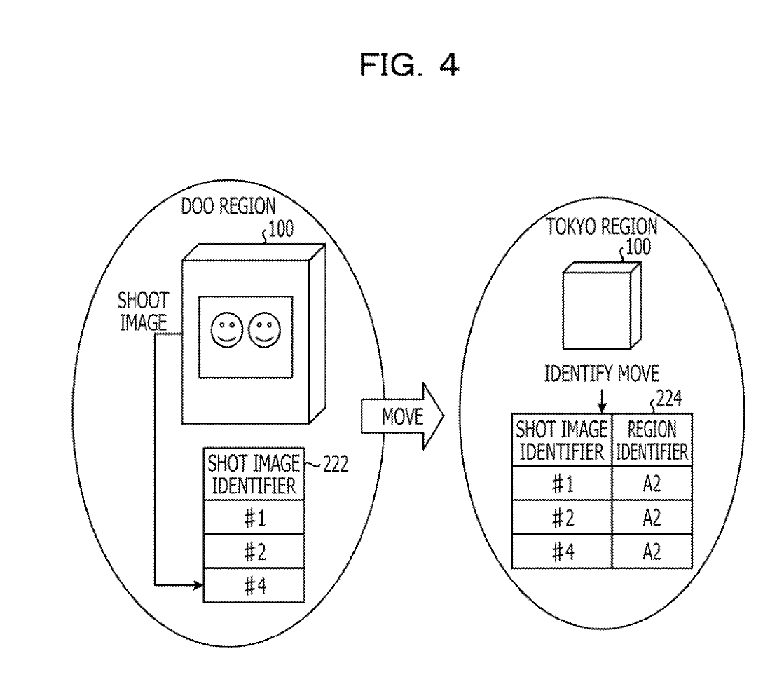

FIG. 4 illustrates an exemplary new shot table and an exemplary image search table. It is assumed in FIG. 4, for example, that a user of the mobile phone 100 shoots images in the Doo region, then moves from the Doo region to the Tokyo region by plane while the mobile phone 100 is kept powered off, and then powers on the mobile phone 100 in the Tokyo region.

If the user shoots images in the Doo region at first, the image storage control unit 206 stores identifiers of the shot images in the new shot table 222 in order. Assume, for example, that shot image identifiers “#1, #2, #4” are stored in the new shot table 222, and that the user removed an image corresponding to a shot image identifier “#3”. Immediately after an image is shot, as described here, the image storage control unit 206 just stores a shot image identifier in the new shot table 222 without connecting the shot image identifier with a region identifier for identifying a region where the image was shot.

After the user moves to the Tokyo region and powers on the mobile phone 100 in the Tokyo region, then, the move identifying unit 212 identifies that the mobile phone 100 has moved from the first region (Doo region) to the second region (Tokyo region). Then, the connection unit 213 connects the identifiers “#1, #2, #4” stored in the new shot table 222 with the region identifier “A2” of the first region (Doo region), and then stores the connected identifiers and region identifier in the image search table 224. Then, the connection unit 213 removes the identifier of the image in the new shot table 222.

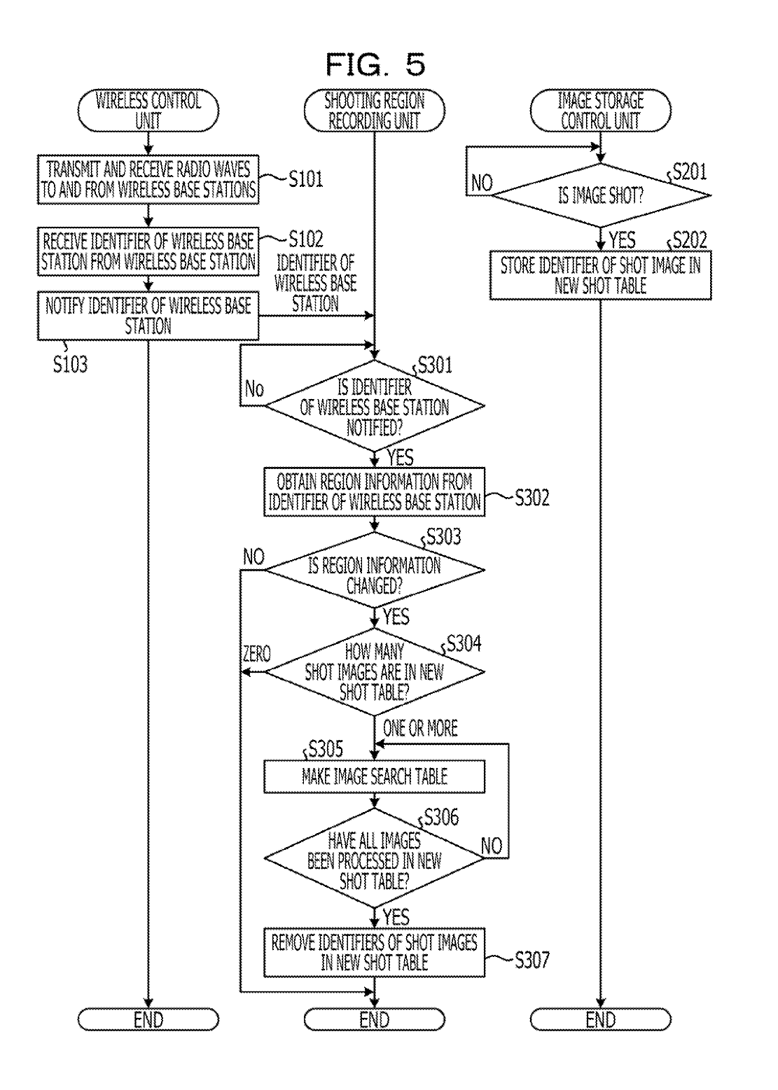

FIG. 5 illustrates an exemplary operation of the mobile phone of the embodiment. As illustrated in FIG. 5, the wireless control unit 202 transmits and receives radio waves to and from wireless base stations at regular intervals (step S101). Upon receiving a radio wave transmitted by a nearby wireless base station, for example, the wireless control unit 202 transmits a radio wave back to the wireless base station in response to the received radio wave. Then, the wireless control unit 202 receives an identifier of the wireless base station transmitted from the wireless base station (step S102). The wireless control unit 202 can thereby detect the identifier of the wireless base station around which the mobile phone 100 is located. Then, the wireless control unit 202 notifies the shooting region recording unit 210 of the identifier of the detected wireless base station (step S103).

Meanwhile, the image storage control unit 206 identifies whether the image shooting unit 204 has shot an image (step S201). Upon identifying that an image is shot (YES of step S201), the image storage control unit 206 stores an identifier of the shot image in the new shot table 222 (step S202). Incidentally, the image storage control unit 206 stores the identifier of the shot image in the new shot table 222, and stores substance data of the shot image in the substance data storage unit 228, as well. Every time an image is shot, the identifier of the shot image is stored in the new shot table 222 in order.

Meanwhile, the region information obtaining unit 211 identifies whether an identifier of a wireless base station is notified (step S301). Upon identifying that an identifier of a wireless base station is notified (YES of step S301), the region information obtaining unit 211 obtains region information from the identifier of the notified wireless base station (step S302). Specifically, the region information obtaining unit 211 refers to the region-base station conversion table 226, extracts a region identifier corresponding to the identifier of the notified wireless base station, and obtains region information corresponding to the extracted region identifier.

Then, the move identifying unit 212 identifies whether the region information is changed on the basis of the obtained region information (step S303). Specifically, the move identifying unit 212 compares the last obtained region information with the region information obtained this time, and identifies a change of the region information if there is a difference. Upon identifying no change of the region information (NO of step S303), the move identifying unit 212 ends the process.

Meanwhile, upon a change of the region information being identified (YES of step S303), the connection unit 213 checks the number of shot images in the new shot table 222 (step S304). Specifically, the connection unit 213 checks the number of the shot images in accordance with the number of the identifiers of the images stored in the new shot table 222. If the number of the shot images is zero in the new shot table 222, for example, no identifier of an image is stored in the new shot table 222, the connection unit 213 ends the process.

If the number of the shot images is one or more in the new shot table 222, then, the connection unit 213 makes the image search table 224 (step S305). Specifically, the connection unit 213 connects an identifier of an image stored in the new shot table 222 with the region information before being changed (the last obtained region information), and stores the connected identifier and region information in the image search table 224. To put it more specifically, the connection unit 213 connects an identifier of an image stored in the new shot table 222 with the region identifier corresponding to the region information before being changed, and stores the connected identifier and region identifier in the image search table 224.

Then, the connection unit 213 identifies whether the image search table 224 has been made for all the images in the new shot table 222 (step S306). If an image not having been processed remains in the new shot table 222 (NO of step S306), the connection unit 213 returns to the step S305 and makes the image search table 224 in order. Meanwhile, upon identifying the image search table 224 as having been made for all the images in the new shot table 222 (YES of step S306), the connection unit 213 removes the identifiers of the shot images in the new shot table 222 (step S307).

According to the mobile phone 100 and the method for image management of the embodiment, as described above, a shot image is just stored immediately after being shot. The shot image is not connected with region information regarding where the image was shot until the region where the mobile phone 100 is located is identified as having been changed. Thus, according to the mobile phone 100 and the method for image management of the embodiment, a shot image is not connected with region information regarding where the image is shot every time the image is shot. As the mobile phone 100 being located out of the service coverage and being unable to transmit or receive radio waves to and from wireless base stations cannot obtain region information, for example, it is difficult to connect a shot image with region information regarding where the image was shot. According to the embodiment, meanwhile, even if images are shot when the mobile phone 100 is located out of the service coverage, the shot images are collectively connected with the region information in which the mobile phone 100 was located before moving, after the mobile phone 100 is identified as having been moved to another region. The mobile phone 100 can thereby certainly connect the shot images with the region where the images were shot.

Further, according to the embodiment, as the shot images are collectively connected with the region information in which the mobile phone 100 was located before moving, after the mobile phone 100 is identified as having been moved to another region, how many times the connections are processed can be reduced as compared with in a case where an image is connected every time the image is shot. Further, according to the embodiment, after shooting a plurality of images in a certain region and before moving to another region, the user can remove an identifier of an image which the user does not want to connect with the region information regarding where the image was shot so that only desirable images can be connected with the region information regarding where the images were shot. As a result, user-friendliness can be enhanced.

Further, according to the mobile phone 100 and the method for image management of the embodiment, one region includes a plurality of adjacent wireless base stations. Then, according to the mobile phone 100 and the method for image management of the embodiment, the mobile phone 100 connects a shot image and region information rather than a shot image and an identifier of a wireless base station. The region information may be too broad to identify where the user was located, comparing to the identifier of a wireless base station. Thus, according to the embodiment, the region information corresponds to prefectures. Therefore, the user's behavior history may not be revealed in detail beyond necessity. Thus, it is preferable from a viewpoint of protecting the user's privacy.

Further, according to the mobile phone 100 and the method for image management of the embodiment, the wireless control unit transmits and receives radio waves to and from a wireless base station. The shooting region recording unit detects an identifier of the wireless base station covering the mobile phone 100 in its service coverage, and obtains region information on the basis of the identifier of the detected wireless base station. The mobile phone 100 can thereby reduce power consumption as compared with a case where region information is obtained on the basis of GPS radio waves transmitted from the GPS satellites by means of GPS positioning every time an image is shot.

Incidentally, the embodiment has been mainly explained as to an electronic apparatus and a method for image management. The embodiment is not limited to the above. By running an image management program prepared in advance on a computer so that a function similar to that of the above embodiment can be implemented. That is, the computer stores an image shot by an image shooting unit which shoots an image in a storage unit and carries out a process for obtaining region information indicating in which one of a plurality of regions an apparatus is located by running the image management program. Further, a process for identifying whether the apparatus has moved from a first region to a second region on the basis of the obtained region information of the apparatus is run by means of the image management program. Further, upon the apparatus being identified as having moved from the first region to the second region owing to the identification, a process for connecting an image shot in the first region stored in the storage unit with a region identifier of the first region is run by means of the image management program. Incidentally, the image management program can be distributed to the computer via a communication network such as the Internet. Further, the image management program can be recorded on a memory that the computer is provided with, a hard disk or another computer-readable recording medium, and can be run by being read from the recording medium by the computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile electronic apparatus comprising:
a storage unit which stores an image shot by an image shooting unit;
a region information obtaining unit which obtains region information indicating in which one of a plurality of regions the mobile electronic apparatus is located;
a move identifying unit which identifies whether the mobile electronic apparatus moved from a first region to a second region on the basis of the region information obtained by the region information obtaining unit; and
a connection unit which connects, upon the move identifying unit identifying that the mobile electronic apparatus moved from the first region to the second region, an image stored in the storage unit after the mobile electronic apparatus moved from another region to the first region with a region identifier of the first region.

2. The mobile electronic apparatus according to claim 1, further comprising:
a wireless control unit which receives radio waves from a plurality of wireless base stations so as to detect an identifier of one of the wireless base stations covering the mobile electronic apparatus in service coverage; and
a region-base station conversion table in which a plurality of region identifiers is each connected with a plurality of wireless base station identifiers, wherein
the region information obtaining unit obtains region information of the mobile electronic apparatus on the basis of the identifier of the wireless base station detected by the wireless control unit and the region-base station conversion table.

3. The mobile electronic apparatus according to claim 1, further comprising a new shot table in which an identifier of an image shot by the image shooting unit is stored, wherein
upon the move identifying unit identifying that the mobile electronic apparatus moved from the first region to the second region, the connection unit connects an identifier of an image stored in the new shot table with a region identifier of the first region so as to store the connected identifier and the region identifier in an image search table, and the connection unit removes the identifier of the image in the new shot table.

4. A method for image management to be carried out by a mobile electronic apparatus having a storage unit which stores an image shot by an image shooting unit, the method carried out by the mobile electronic apparatus comprising:
obtaining region information indicating in which one of a plurality of regions the mobile electronic apparatus is located;
identifying whether the mobile electronic apparatus moved from a first region to a second region on the basis of the obtained region information; and
connecting, upon a fact that the mobile electronic apparatus moved from the first region to the second region, an image stored in the storage unit after the mobile electronic apparatus moved from another region to the first region with a region identifier of the first region.

5. A computer-readable storage medium in which an image management program for running a process by means of a mobile electronic apparatus having a storage unit which stores an image shot by an image shooting unit, the process comprising:
obtaining region information indicating in which one of a plurality of regions the mobile electronic apparatus is located;
identifying whether the mobile electronic apparatus moved from a first region to a second region on the basis of the obtained region information; and
connecting, upon a fact that the mobile electronic apparatus moved from the first region to the second region, an image stored in the storage unit after the mobile electronic apparatus moved from another region to the first region with a region identifier of the first region.
